(19) United States
(12) Patent Application Publication
(10) Pub. No.: US 2006/0227407 A1
(43) Pub. Date: Oct. 12, 2006

(54) Electrophoretic display panel

(75) Inventors: Guofu Zhou, Eindhoven (NL); Masaru Yasui, Nishiku (JP); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/556,517

(22) PCT Filed: May 12, 2004
(86) PCT No.: PCT/IB04/50644

§ 371 Date: Nov. 14, 2005

(30) Foreign Application Priority Data
May 16, 2003 (EP) 03101385.7

(51) Int. Cl. G02B 26/00

(52) U.S. Cl. 359/296

(57) ABSTRACT

The electrophoretic display panel (1), for displaying a picture and a subsequent picture, has drive means (100) which are arranged for controlling the potential difference picture potential difference having a picture value and an associated picture duration representing a picture energy for bringing the particles (6) from one the positions for displaying the picture, and subsequently to be an inter-picture potential difference for bringing the particles (6) into one of the extreme positions which is closest to the position of the particles (6) for displaying the subsequent picture, and subsequently to be a subsequent picture potential difference for bringing the particles (6) into one of the positions for displaying the subsequent picture. For the display panel (1) to be able to have inter-picture appearances which are at the largest relatively medium visible and in which the dependency on the history due to the charging of the insulators as a result of the picture potential difference is substantially reduced in the subsequent picture update, the drive means (100) are further arranged for controlling for each picture element (2) the inter-picture potential difference to comprise a pull-back potential difference having a pull-back value and an associated pull-back duration representing a pull-back energy, the pull-back value having a sign opposite to a sign of the picture value and the pull-back energy being substantially equal to the picture energy.

The invention relates to an electrophoretic display panel, for displaying a picture and a subsequent picture, comprising:
an electrophoretic medium comprising charged particles;
a plurality of picture elements;
a first and a second electrode associated with each picture element for receiving a potential difference; and
drive means,
   the charged particles being able to occupy a position being one of extreme positions near the electrodes and intermediate positions in between the electrodes, and
   the drive means being arranged for controlling the potential difference of each picture element
to be a picture potential difference having a picture value and an associated picture duration representing a picture energy for bringing the particles from one of the extreme positions into one of the positions for displaying the picture, and subsequently
to be an inter-picture potential difference for bringing the particles into one of the extreme positions which is closest to the position of the particles for displaying the subsequent picture, and subsequently
to be a subsequent picture potential difference for bringing the particles into one of the positions for displaying the subsequent picture.

An embodiment of the electrophoretic display panel of the type mentioned in the opening paragraph is described in non-prepublished European Patent application 02079203.2 (PHNL021000).

In electrophoretic display panels in general, the picture elements have, during the display of each one of the pictures, appearances determined by the positions of the charged particles between the electrodes. As a consequence of the inter-picture potential differences the picture elements have inter-picture appearances, which are, in general, mutually substantially equal. Unfortunately, the picture elements having the mutually substantially equal inter-picture appearances are relatively much visible for an observer, as in general the picture appearances and the subsequent picture appearances of the picture elements are unrelated. In the described electrophoretic display panel, each inter-picture potential difference brings the particles into the extreme position which is closest to the position of the particles for displaying the subsequent picture. As a result, an observer perceives a relatively smooth transition from the picture via an estimate of the subsequent picture to the subsequent picture. Therefore the inter-picture appearances are relatively little visible. Furthermore, insulating layers are present between the electrodes, which become charged as a result of the potential differences. The charge present at the insulating layers is determined by the charge initially present at the insulating layers and the subsequent history of the potential differences. Therefore, the positions of the particles depend not only on the potential differences, but also on the history of the potential differences.

It is a drawback of the described display panel that the dependency on the history due to the charging of the insulators as a result of the picture potential differences is present in the subsequent picture update.

It is an object of the invention to provide a display panel of the kind mentioned in the opening paragraph which is able to have inter-picture appearances which are at the largest relatively medium visible and in which the dependency on the history due to the charging of the insulators as a result of the picture potential difference is substantially reduced in the subsequent picture update.

The object is thereby achieved that the drive means are further arranged for controlling for each picture element the inter-picture potential difference to comprise a pull-back potential difference having a pull-back value and an associated pull-back duration representing a pull-back energy, the pull-back value having a sign opposite to a sign of the picture value and the pull-back energy being substantially equal to the picture energy.

As a result of the sign of the pull-back value being opposite to the sign of the picture value and the pull-back energy being substantially equal to the picture energy the charging of the insulators due to the picture potential difference is substantially reduced. Furthermore, the inter-picture appearance of each picture element comprises two sub-inter-picture appearances: the first sub-inter-picture appearance is a consequence of the pull-back potential difference and the second sub-inter-picture appearances is a consequence of the particles being in one of the extreme positions which is closest to the position of the particles for displaying the subsequent picture. These two sub-inter-picture appearances are equal, if as a consequence of the pull-back potential difference the particles are already in the extreme position which is closest to the position of the particles for displaying the subsequent picture. These two sub-inter-picture appearances are unequal otherwise. In general, half of the number of the picture elements has two equal sub-inter-picture appearances. Because the display panel shows an estimate of the subsequent picture as a consequence of the second sub-inter-picture appearances, the display panel shows a partial estimate of the subsequent picture as a consequence of the first sub-inter-picture appearances. As a result, an observer perceives a relatively smooth transition from the picture, via a partial estimate of the subsequent picture, via an estimate of the subsequent picture to the subsequent picture. Therefore, the inter-picture appearances are at the largest relatively medium visible. It is obvious that the plurality of picture elements for displaying one of the pictures may be smaller or equal to the toal available number of picture elements of the display panel.

It is favorable, if the drive means are arranged for controlling for each picture element the picture potential difference for bringing the particles from the extreme position which is closest to the position of the particles for displaying the picture into the position for displaying the picture. Then, as a consequence of the pull-back potential differences, the display panel shows an estimate of the picture as the partial estimate of the subsequent picture. As a result, an observer perceives a relatively smooth transition from the picture, via an estimate of the picture, via an estimate of the subsequent picture to the subsequent picture. Then the inter-picture appearances are even less visible.

The pull-back energy supplied to each picture element may be controlled by controlling both the pull-back value and the associated pull-back duration.

If the drive means are arranged for controlling for each picture element the pull-back value to have a magnitude being at least one order of magnitude smaller than a magnitude of the picture value, the pull-back value is relatively low.

It is favorable, if the drive means are arranged for controlling for each picture element the pull-back value to have a magnitude substantially equal to a magnitude of the picture value. Then the pull-back potential difference is substantially opposite to the picture potential and the charging of the insulators due to each picture potential difference is substantially undone. Furthermore, then relatively simple drive electronics may be used having only relatively few different values of the potential differences, e.g. three different values, e.g. −15 Volts, 0, 15 Volts.

It is favorable, if the drive means are further arranged for controlling for each picture element having the particles as a result of the pull-back potential difference in the extreme position which is most distant to the position of the particles for displaying the subsequent picture, the inter-picture potential difference to further comprise a reset potential difference after the pull-back potential difference for bringing the particles into the extreme position which is closest to the position of the particles for displaying the subsequent picture, the reset potential difference representing an energy being at least as large as a reference energy representing an energy to change the position of particles from one of the extreme positions to the other one of the extreme positions. Then the subsequent picture update is relatively accurate. It is preferred if, furthermore, the drive means are further arranged for controlling the energy represented by the reset potential difference to be substantially larger than the reference energy. Then the subsequent picture update is even more accurate. Such reset potential differences are described in the non-prepublished European Patent application 03100133.2 (PHNL030091).

It is furthermore favorable, if the drive means are further arranged for controlling for each picture element the inter-picture potential difference to comprise a first sequence of preset potential differences prior to the pull-back potential difference, the first sequence of preset potential differences having preset values and associated preset durations, the preset values in the sequence alternating in sign, each preset potential difference representing a preset energy sufficient to release particles present in one of the extreme positions from their position but insufficient to enable said particles to reach the other one of the extreme positions. As an advantage, due to the first sequences of preset potential differences the picture quality increases. Such sequences of preset values are described in the non-prepublished European Patent application 02077017.8 (PHNL020441). It is even more favorable, if, furthermore, the drive means are further arranged for controlling for each picture element having a reset potential difference the inter-picture potential difference to comprise a second sequence of preset potential differences between the pull-back potential difference and the reset potential difference. It is also even more favorable, if, furthermore, the drive means are further arranged for controlling for each picture element having a reset potential difference the inter-picture potential difference to comprise a third sequence of preset potential differences after being the reset potential difference. As a consequence of the sequences of preset potential differences the picture quality is increased. It is preferred, if the drive means are arranged for controlling for each picture element having a reset potential difference the inter-picture potential difference to comprise the first sequence, the second sequence and the third sequence of preset potential differences.

These and other aspects of the display panel of the invention will be further elucidated and described with reference to the drawings, in which:

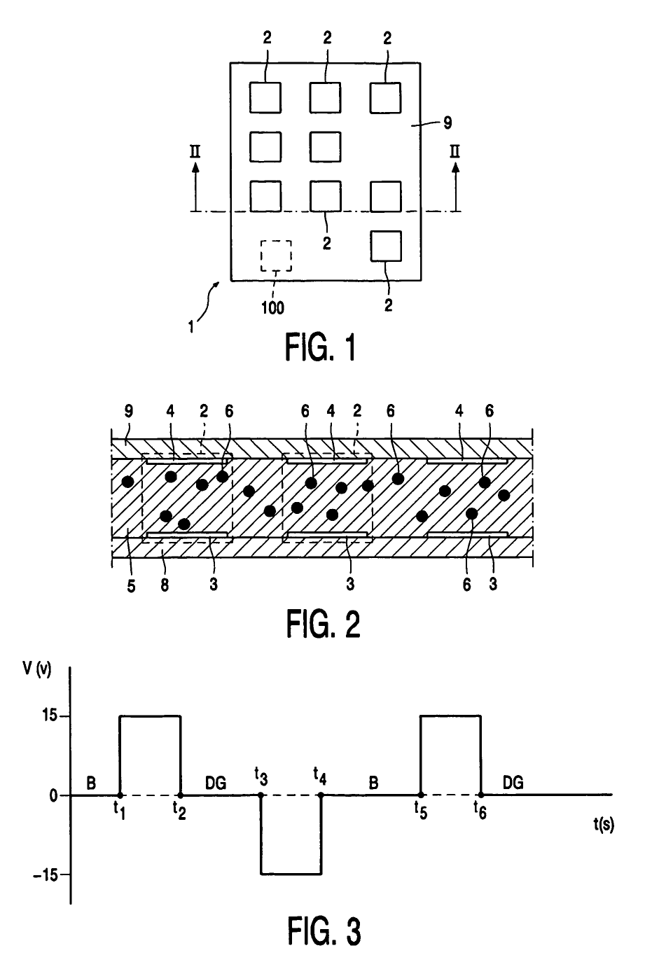

FIG. 1 shows diagrammatically a front view of an embodiment of the display panel;

FIG. 2 shows diagrammatically a cross-sectional view along II-II in FIG. 1;

FIG. 3 shows diagrammatically the potential difference as a function of time for a picture element in the embodiment;

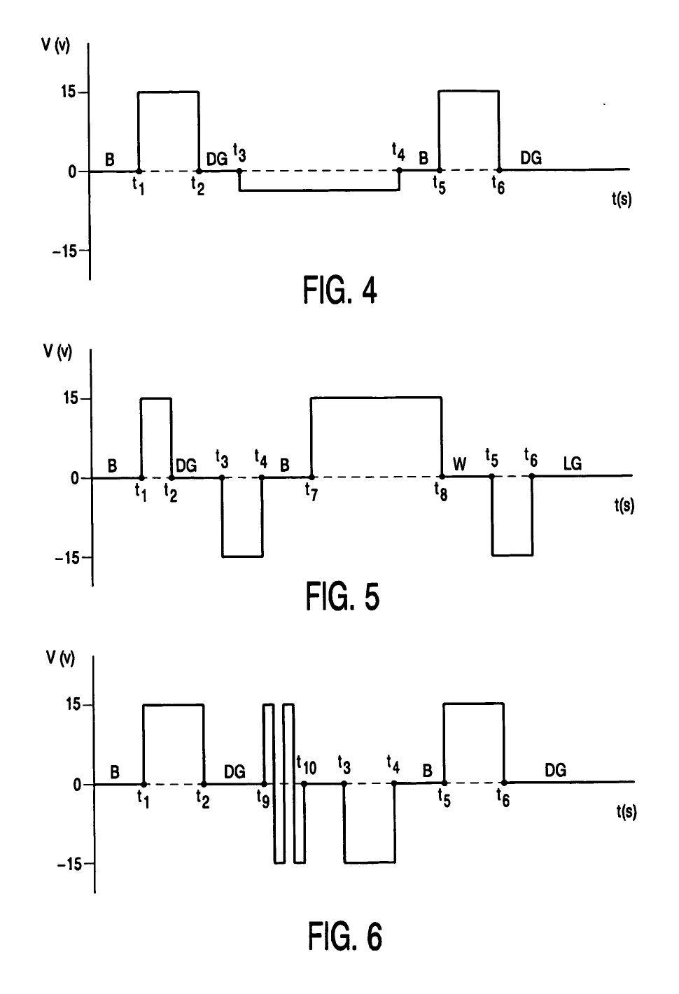

FIG. 4 shows diagrammatically the potential difference as a function of time for a picture element in another embodiment;

FIG. 5 shows diagrammatically the potential difference as a function of time for a picture element in another embodiment;

FIG. 6 shows diagrammatically the potential difference as a function of time for a picture element in another embodiment, and

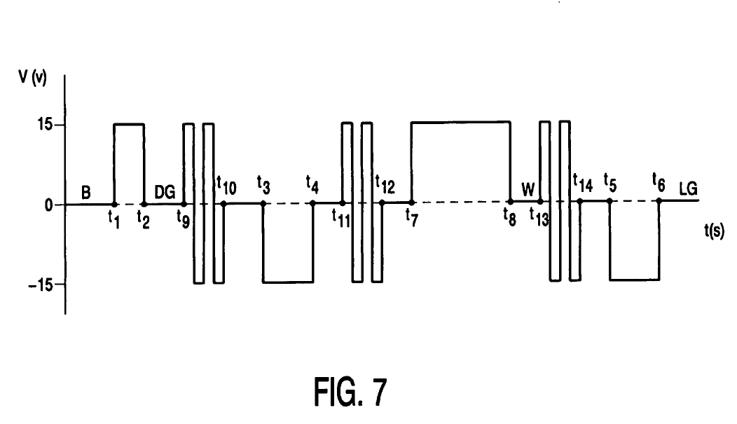

FIG. 7 shows diagrammatically the potential difference as a function of time for a picture element in another embodiment.

In all the Figures corresponding parts are referenced to by the same reference numerals.

FIGS. 1 and 2 show the embodiment of the display panel 1 having a first substrate 8, a second opposed substrate 9 and a plurality of picture elements 2. Preferably, the picture elements 2 are arranged along substantially straight lines in a two-dimensional structure. Other arrangements of the picture elements 2 are alternatively possible, e.g. a honeycomb arrangement. An electrophoretic medium 5, having charged particles 6 in a fluid, is present between the substrates 8,9. A first and a second electrode 3,4 are associated with each picture element 2 for receiving a potential difference. In FIG. 2 the first substrate 8 has for each picture element 2 a first electrode 3, and the second substrate 9 has for each picture element 2 a second electrode 4. The charged particles 6 are able to occupy a position being one of extreme positions near the electrodes 3,4 and intermediate positions in between the electrodes 3,4. Each picture element 2 has an appearance determined by the position of the charged particles 6 between the electrodes 3,4. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the picture element 2 is e.g. white. Here it is considered that the picture element 2 is observed from the side of the second substrate 9. When the charged particles 6 are in a second extreme position, i.e. near the second electrode 4, as a result of the potential difference being of opposite polarity, i.e. −15 Volts, the appearance of the picture element 2 is black. When the charged particles 6 are in one of the intermediate positions, i.e. in between the electrodes 3,4, the picture element 2 has one of the intermediate appearances, e.g. light gray, middle gray and dark gray, which are gray levels between white and black. The drive means 100 are arranged for controlling the potential difference of each picture element 2 to be a picture potential difference having a picture value and an associated picture duration representing a picture energy for bringing the particles 6 from one of the extreme positions into one of the positions for displaying the picture, and subsequently to be an inter-picture potential difference for bringing the particles 6 into one of the extreme positions which is closest to the position of the particles 6 for displaying the subsequent picture, and subsequently to be a subsequent picture potential difference for bringing the particles 6 into one of the positions for displaying the subsequent picture. Furthermore, the drive means 100 are further arranged for controlling for each picture element 2 the inter-picture potential difference to comprise a pull-back potential difference having a pull-back value and an associated pull-back duration representing a pull-back energy, the pull-back value having a sign opposite to a sign of the picture value and the pull-back energy being substantially equal to the picture energy. In an example, the picture appearance of a picture element 2 is dark gray and the subsequent picture appearance of the picture element 2 is also dark gray. For this example, the potential difference of the picture element 2 is shown as a function of time in FIG. 3. Prior to the application of the picture potential difference the appearance of the picture element 2 is black, denoted by B. The picture potential difference is present from time t1 to time t2 and has e.g. a picture value of 15 Volts and an associated picture duration of 50 ms. As a result, the appearance of the picture element 2 is dark gray, denoted by DG. The inter-picture potential difference comprises a pull-back potential difference, present from time t3 to time t4, having a pull-back value of e.g. −15 Volts and an associated pull-back duration of e.g. 50 ms. The pull-back value has a sign opposite to the sign of the picture value and the pull-back energy is substantially equal to the picture energy. This is also an example of the drive means 100 being arranged for controlling for each picture element 2 the picture potential difference for bringing the particles 6 from the extreme position which is closest to the position of the particles for displaying the picture into the position for displaying the picture. Furthermore, this is an example of the pull-back value having a magnitude substantially equal to the magnitude of the picture value. As a result, the charging of the insulators due to the picture potential difference is substantially undone whereas the appearance of the picture element 2 is black. The subsequent picture potential difference is present from time t5 to time t6 and has e.g. a subsequent picture value of 15 Volts and an associated subsequent picture duration of 50 ms. As a result, the picture element 2 has an appearance being dark gray for displaying the subsequent picture.

In another embodiment, the drive means 100 are arranged for controlling for each picture element 2 the pull-back value to have a magnitude being at least one order of magnitude smaller than a magnitude of the picture value. In an example, the potential difference of another picture element 2 is shown as a function of time in FIG. 4. For this picture element 2 the picture appearance is dark gray and the subsequent picture appearance is also dark gray. The picture potential difference is present from time t1 to time t2 and has e.g. a picture value of 15 Volts and an associated duration of 50 ms, and the appearance of the picture element 2 for displaying the picture is dark gray. The pull-back potential difference is present from time t3 to time t4 and has e.g. a pull-back value of −0.5 Volts and an associated pull-back duration of 1600 ms. Then the pull-back energy is a little larger than the picture energy. As a result, the charging of the insulators due to the picture potential difference is substantially reduced, whereas the appearance of the picture element 2 is black.

In another embodiment, the drive means 100 are further arranged for controlling for each picture element 2 having the particles 6 as a result of the pull-back potential difference in the extreme position which is most distant to the position of the particles 6 for displaying the subsequent picture, the inter-picture potential difference to further comprise a reset potential difference after the pull-back potential difference for bringing the particles 6 into the extreme position which is closest to the position of the particles 6 for displaying the subsequent picture, the reset potential difference representing an energy being at least as large as a reference energy representing an energy to change the position of particles 6 from one of the extreme positions to the other one of the extreme positions. In an example, the picture appearance of a picture element 2 is dark gray and the subsequent picture appearance of the picture element 2 is light gray. For this example, the potential difference of the picture element 2 is shown as a function of time in FIG. 5. Prior to the application of the picture potential difference the appearance of the picture element 2 is black. The picture potential difference is present from time t1 to time t2 and has e.g. a picture value of 15 Volts and an associated picture duration of 50 ms. As a result, the appearance of the picture element 2 is dark gray. The inter-picture potential difference comprises a pull-back potential difference and a reset potential difference after the pull-back potential difference. The pull-back potential difference, present from time t3 to time t4, has a pull-back value −15 Volts and an associated pull-back duration of 50 ms. The reset potential difference, present from time t7 to time t8, has a reset value of e.g. 15 Volts and an associated reset duration of 200 ms, representing an energy equal to the reference energy. As a result, the appearance of the picture element 2 is white, denoted by W. The subsequent picture potential difference is present from time t5 to time t6 and has e.g. a subsequent picture value of −15 Volts and an associated subsequent picture duration of e.g. 50 ms. As a result, the picture element 2 has an appearance being light gray, denoted by LG, for displaying the subsequent picture. In a variation on the embodiment, the drive means 100 are further arranged for controlling the energy of the reset potential difference to be substantially larger than the reference energy. As an example, consider the reset potential difference of FIG. 5, present from time t7 to time t8, to have e.g. a reset value of 15 Volts and an associated reset duration of 500 ms, representing an energy which is larger than the reference energy.

In another embodiment, the drive 100 means are further arranged for controlling for each picture element 2 the inter-picture potential difference to comprise a first sequence of preset potential differences prior to the pull-back potential difference, the first sequence of preset potential differences having preset values and associated preset durations, the preset values in the sequence alternating in sign, each preset potential difference representing a preset energy sufficient to release particles 6 present in one of the extreme positions from their position but insufficient to enable said particles 6 to reach the other one of the extreme positions. In an example, the picture appearance of a picture element 2 is dark gray and the subsequent picture appearance of the picture element 2 is also dark gray. For this example, the potential difference of the picture element 2 is shown as a function of time in FIG. 6. Prior to the application of the picture potential difference the appearance of the picture element 2 is black. The picture potential difference is present from time t1 to time t2 and has e.g. a picture value of 15 Volts and an associated picture duration of 50 ms. As a result, the appearance of the picture element 2 is dark gray. The inter-picture potential difference comprises a first sequence of preset potential differences prior to the pull-back potential difference. In the example, the first sequence of preset potential differences has 4 preset values, subsequently 15 Volts, −15 Volts, 15 Volts and −15 Volts, applied from time t9 to time t10. Each preset value is applied for e.g. 20 ms. The time interval between t10 and t3 may be negligibly small. The pull-back potential difference, present from time t3 to time t4, has a pull-back value of e.g. −15 Volts and an associated pull-back duration of e.g. 50 ms. The subsequent picture potential difference is present from time t5 to time t6 and has e.g. a subsequent picture value of 15 Volts and an associated subsequent picture duration of 50 ms. As a result, the picture element 2 has an appearance being dark gray for displaying the subsequent picture.

In a variation on the embodiment, the drive means 100 are further arranged for controlling for each picture element 2 having a reset potential difference the inter-picture potential difference to comprise a second sequence of preset potential differences between the pull-back potential difference and the reset potential difference. In a further variation on the embodiment the drive means 100 are further arranged for controlling for each picture element 2 having a reset potential difference the inter-picture potential difference to comprise a third sequence of preset potential differences after being the reset potential difference. In an example, the picture appearance of a picture element 2 is dark gray and the subsequent picture appearance of the picture element 2 is light gray. For this example, the potential difference of the picture element 2 is shown as a function of time in FIG. 7. Prior to the application of the picture potential difference the appearance of the picture element 2 is black. The inter-picture potential difference comprises a first sequence of preset potential differences, subsequently a pull-back potential difference, subsequently a second sequence of preset potential differences, subsequently a reset potential difference and subsequently a third sequence of preset potential differences. In the example, the first sequence of preset potential differences has 4 preset values, subsequently 15 Volts, −15 Volts, 15 Volts and −15 Volts, applied from time t9 to time t10. Each preset value is applied for e.g. 20 ms. The time interval between t10 and t3 may be negligibly small. The pull-back potential difference, present from time t3 to time t4, has a pull-back value of −15 Volts and an associated pull-back duration of 50 ms. The second sequence of preset potential differences has 4 preset values, subsequently 15 Volts, −15 Volts, 15 Volts and −15 Volts, applied from time t11 to time t12. Each preset value is applied for e.g. 20 ms. The time interval between t12 and t7 may be negligibly small. The reset potential difference, present from time t7 to time t8, has a reset value of e.g. 15 Volts and an associated reset duration of 600 ms. As a result, the appearance of the picture element 2 is white. The third sequence of preset potential differences has 4 preset values, subsequently 15 Volts, −15 Volts, 15 Volts and −15 Volts, applied from time t13 to time t14. Each preset value is applied for e.g. 20 ms. The time interval between t14 and t5 may be negligibly small. The subsequent picture potential difference is present from time t5 to time t6 and has e.g. a subsequent picture value of −15 Volts and an associated subsequent picture duration of e.g. 50 ms. As a result, the picture element 2 has an appearance being light gray for displaying the subsequent picture.

1. An electrophoretic display panel (1), for displaying a picture and a subsequent picture, comprising:
an electrophoretic medium (5) comprising charged particles (6);
a plurality of picture elements (2);
a first and a second electrode (3,4) associated with each picture element (2) for receiving a potential difference; and
drive means (100),
the charged particles (6) being able to occupy a position being one of extreme positions near the electrodes (3,4) and intermediate positions in between the electrodes (3,4), and
the drive means (100) being arranged for controlling the potential difference of each picture element (2)
to be a picture potential difference having a picture value and an associated picture duration representing a picture energy for bringing the particles (6) from one of the extreme positions into one of the positions for displaying the picture, and subsequently
to be an inter-picture potential difference for bringing the particles (6) into one of the extreme positions which is closest to the position of the particles (6) for displaying the subsequent picture, and subsequently
to be a subsequent picture potential difference for bringing the particles (6) in into one of the positions for displaying the subsequent picture.
characterized in that the drive means (100) are further arranged for controlling for each picture element (2) the inter-picture potential difference to comprise a pull-back potential difference having a pull-back value and an associated pull-back duration representing a pull-back energy, the pull-back value having a sign opposite to a sign of the picture value and the pull-back energy being substantially equal to the picture energy.

2. A display panel (1) as claimed in claimed 1 characterized in that the drive means (100) are arranged for controlling for each picture element (2) the picture potential difference for bringing the particles (6) from the extreme position which is closest to the position of the particles (6) for displaying the picture into the position for displaying the picture.

3. A display panel (1) as claimed in claimed 2 characterized in that the drive means (100) are arranged for controlling for each picture element (2) the pull-back value to have a magnitude being at least one order of magnitude smaller than a magnitude of the picture value.

4. A display panel (1) as claimed in claimed 2 characterized in that the drive means (100) are arranged for controlling for each picture element (2) the pull-back value to have a magnitude substantially equal to a magnitude of the picture value.

5. A display panel (1) as claimed in claim 2 characterized in that the drive means (100) are further arranged for controlling for each picture element (2) having the particles (6) as a result of the pull-back potential difference in the extreme position which is most distant to the position of the particles (6) for displaying the subsequent picture, the inter-picture potential difference to further comprise a reset potential difference after the pull-back potential difference for bringing the particles (6) into the extreme position which is closest to the position of the particles (6) for displaying the subsequent picture, the reset potential difference representing an energy being at least as large as a reference energy representing an energy to change the position of particles (6) from one of the extreme positions to the other one of the extreme positions.

6. A display panel (1) as claimed in claim 5 characterized in that the drive means (100) are further arranged for controlling the energy represented by the reset potential difference to be substantially larger than the reference energy.

7. A display panel (1) as claimed in claim 5 characterized in that the drive means (100) are further arranged for controlling for each picture element (2) the inter-picture potential difference to comprise a first sequence of preset potential differences prior to the pull-back potential difference, the first sequence of preset potential differences having preset values and associated preset durations, the preset values in the sequence alternating in sign, each preset potential difference representing a preset energy sufficient to release particles (6) present in one of the extreme positions from their position but insufficient to enable said particles (6) to reach the other one of the extreme positions.

8. A display panel (1) as claimed in claim 7 characterized in that the drive means (100) are further arranged for controlling for each picture element (2) having a reset potential difference the inter-picture potential difference to comprise a second sequence of preset potential differences between the pull-back potential difference and the reset potential difference.

9. A display panel (1) as claimed in claim 7 characterized in that the drive means (100) are further arranged for controlling for each picture element (2) having a reset potential difference the inter-picture potential difference to comprise a third sequence of preset potential differences after being the reset potential difference.
